(19) United States
(12) Patent Application Publication
(10) Pub. No.: US 2007/0180713 A1
(43) Pub. Date: Aug. 9, 2007

(54) CARPENTER'S PENCIL SHARPENER

(75) Inventor: Joseph K. Donaldson, Wheaton, IL (US)

Correspondence Address: PATZIK, FRANK & SAMOTNY LTD., 150 SOUTH WACKER DRIVE, SUITE 1500, CHICAGO, IL, 60606, US

(73) Assignee: FLADE LLC, Batavia, IL (US)

(21) Appl. No.: 11/670,629

(22) Filed: Feb. 2, 2007

Related U.S. Application Data
(63) Continuation of application No. 10/875,828, filed on Jun. 24, 2004, now abandoned.
(60) Provisional application No. 60/482,919, filed on Jun. 27, 2003.

(51) Int. Cl. B43L 23/00

(52) U.S. Cl. 30/457

(57) ABSTRACT

A carpenter's pencil sharpener for cutting a point on a flat pencil has a base enclosure and a centering collar rotatably mounted on the base enclosure and cooperatively defining a longitudinal central axis. The base enclosure has a pencil contour surface generally matching a desired contour of the pencil. The collar positions the pencil generally along the central axis during rotation of the collar. A flat blade has a cutting edge positioned along the contour surface at an angle of approximately 10-13 degrees relative to the central axis for cutting against the pencil when the pencil is rotated about the central axis.

### CROSS-REFERENCE TO RELATED APPLICATION

This application is a continuation of U.S. patent application No. 10/875,828, filed Jun. 24, 2004, which claims the benefit of U.S. Provisional Patent Application No. 60/482,919, filed Jun. 27, 2003.

### TECHNICAL FIELD OF THE INVENTION

The present invention relates generally to devices for sharpening pencils and more particularly to sharpeners designed for the flattened style of carpenter's pencils.

### BACKGROUND OF THE INVENTION

The need for a sharpening device designed for the sharpening of a carpenter's pencil has long been well known, as sharpening has generally required the use of a utility knife to accomodate the odd shape of the pencil. The difficulty of sharpening this style of pencil with such a sharpening device without leaving wood on the broad sides of the rectangular pencil lead has long presented a major obstacle. For example, in U.S. Pat. No. 5,077,903 a sharpener is presented with dual rotary cutter assemblies arranged to cut two curves in the point. In U.S. Pat. Nos. 4,759,129 and 4,918,816 four cutters and associated gearing are similarly used to achieve the desired sharpening effect on a carpenter's pencil. In U.S. Pat. No. 4,081,010 a cutting blade is driven around the pencil in a complicated “eccentric” motion by means of cams to achieve the required pencil point shaping. All of these references, however, require complex configurations with many blades, gears and motors.

One solution is presented by U.S. Pat. No. 6,092,293 issued to Donaldson for a pencil sharpener and owned by assignee of this application. Donaldson discloses the use of a curved blade or a blade that is bent to define straight sections which enables the blade to more closely form an ideal contour of the contour of the carpenter's pencil as it is rotated. The curved blade removes enough wood to expose a good writing pencil tip but not too much wood resulting in a weak tip that could break with little pressure.

While providing a high quality sharpener that consistently forms good writing pencil tips, the sharpener of Donaldson can be relatively expensive due to the need to form a curved or bent blade. Thus, another more economical alternative solution, while not necessarily providing quite as good a pencil point as disclosed in Donaldson, is desired.

### SUMMARY OF THE INVENTION

The present invention discloses a simplified and economical solution for a device which will sharpen a carpenter's pencil without the need of providing a curved or bent blade. Particularly, a carpenter's pencil sharpener for cutting a point on a flat pencil has a base enclosure and a centering collar rotatably mounted on the base enclosure. The base enclosure and the centering collar cooperatively generally define a longitudinal central axis. The base enclosure has a pencil contour surface generally matching a desired contour of the pencil. The centering collar positions the pencil generally along the central axis during rotation of the centering collar. A flat blade has a cutting edge positioned along the contour surface at an angle of approximately 10-13 degrees relative to the central axis for cutting against the pencil when the pencil is rotated about the central axis. In other alternatives, the contour surface is generally a right circular cone.

### BRIEF DESCRIPTION OF THE DRAWINGS

Further aspects of the invention will be discerned with reference to the following detailed description when taken in conjunction with the drawings, in which:

FIG. 1 is a perspective view of a sharpening device according to the present invention.

FIG. 2 is a top side elevational view of the sharpening device of FIG. 1;

FIG. 2A is a cross section of the sharpening device of FIG. 1 along line A-A;

FIG. 3 is a simplified collar end view of a portion of the sharpening device of FIG. 1; and

FIG. 4 is a transparent side elevational view of the sharpening device of FIG. 1.

### DETAILED DESCRIPTION OF ILLUSTRATED EMBODIMENT

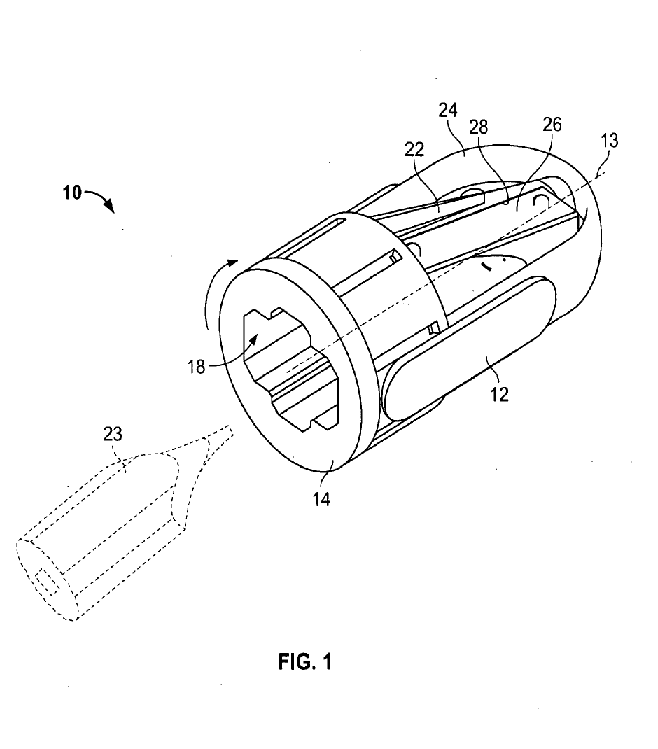

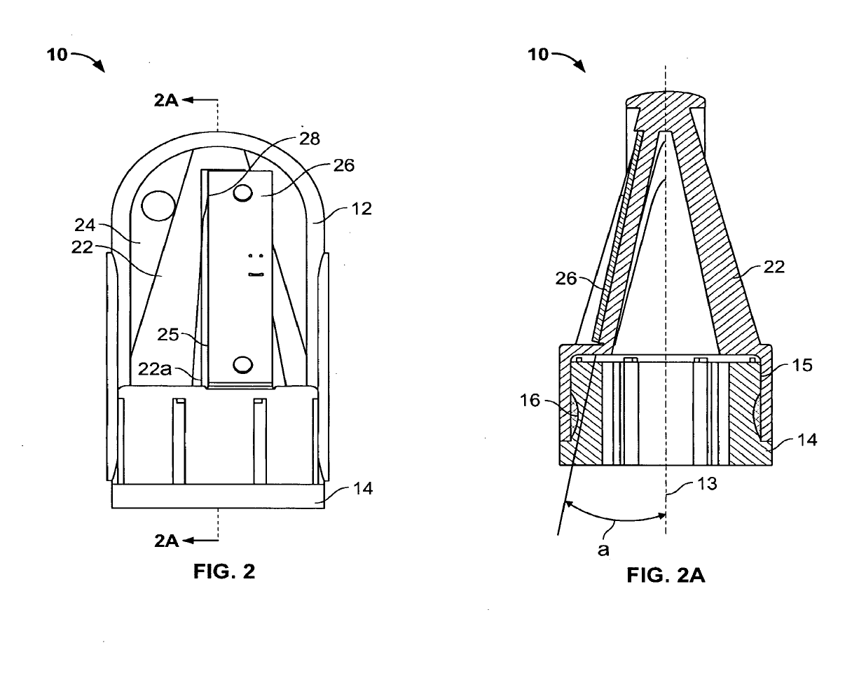

Referring to FIGs. 1-4, a pencil sharpening device or simple sharpener in accordance with the present invention is generally indicated at 10 and has a base or base enclosure 12 and pencil centering mechanism such as a centering collar or pencil holder 14 mounted to the base enclosure for rotation relative thereto. The collar 14 has an encircling shoulder 15 (FIG. 2A) arranged to removably fit within a resilient track 16 (FIG. 2A) encircling the end of the base enclosure 12 for allowing rotation of the collar relative to the base enclosure 12 about a central axis 13.

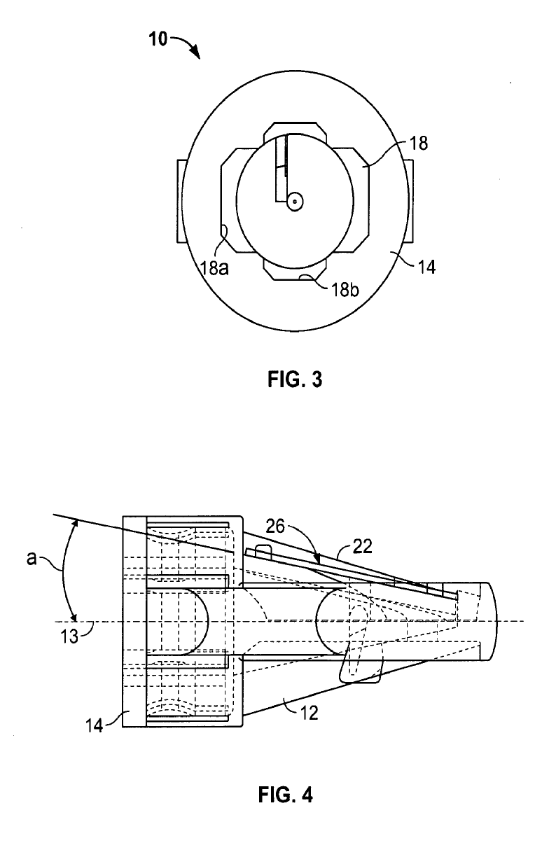

The collar 14 further presents an opening 18 for insertion of a carpenter's pencil 23 to be sharpened, and in the preferred embodiment the collar opening 18 is in the form of intersecting rectangular slots 18a/18b (FIG. 3) designed to accomodate the dimensions of a plurality of sizes of carpenter's pencils. For example, a wide pencil can be positioned within the wide slot 18a and a narrow pencil can be positioned within the narrow slot 18b. Consequently, rotation of the collar 14 with the pencil 23 inserted through the collar into the base enclosure 12 causes the pencil to rotate about the central axis 13 for the sharpening effect as hereinafter described.

Within the base enclosure 12 there is a pencil point contour surface 22 defined about central axis 13, the inside shape of which is depicted in FIG. 2. This contour matches the desired shape of the sharpened end of the pencil; it presents a narrow portion near the point extremity of the pencil and a wider portion further up the pencil shaft away from the point extremity. As shown most clearly in FIGS. 2 and 2A, in this embodiment, this contour surface is of the general shape of a right circular cone oriented to present its narrow portion near the point extremity of the pencil.

A flat straight blade 26 is generally aligned with an edge 22a of the contoured surface 22, and is held on the base enclosure 12 by pin(s) and/or screw(s). It has been determined that positioning the flat straight blade 26 on an incline at an angle ∀ if 10 to 13° relative to the central axis 13 (best shown in FIG. 2A and 4) provides a surprisingly good cut for flat blade on a carpenter's pencil that does not cut away too much of the wood (including on the flat sides) so that enough graphite or lead is exposed to provide a good tip for easy writing. In addition, this angle ∀ of 10 to 13° angle of incline also leaves enough wood on the graphite so that the graphite tip is not too long and weak such that it breaks easily. With this configuration, the slope of the contour surface is also 10-13° relative to the central axis 13.

As best shown in FIG. 2, the base enclosure 12 is open at 24 on one side, being cut-away to allow for removal of debris cut from the pencil during the sharpening process. At this open side the contoured surface 22 is interrupted with a narrow slot opening 25 where the blade 26 is mounted along the contoured surface to present a straight blade edge 28 generally paralles to the contoured surface at the slot opening.

From the foregoing description, it will be apparent that modifications can be made to the apparatus without departing from the teachings of the present invention. Accordingly, the scope of the invention is only to be limited as necessitated by the accompanying claims.

While preferred embodiments of the present invention have been illustrated in the appended drawing and described in the detailed desciption above, the present invention is not limited thereto but only by the scope and spirit of the appended claims.

1. A carpenter's pencil sharpener for cutting a point on a flat pencil, comprising:
a base enclosure having a pencil contour surface generally matching a deisred contour of the pencil;
a centering collar rotatably mounted on said base enclosure, said base enclosure and said centering collar cooperatively defining a longitudinal central axis, said centering collar positioning said pencil generally along said central axis during rotation of said centering collar; and
a flat blade having a cutting edge positioned along said contour suface at an angle of approximately 10-13 degrees relative to said central axis for cutting against said pencil when the pencil is rotated about said central axis.

2. The sharpener of claim 1, wherein said contour surface has the shape of a right circular cone and is defined about said central axis, said contour surface having a straight edge aligned with said cutting edge of said flat blade.

3. The sharpener of claim 1, wherein said centering collar defines an opening shaped to match the cross sectinal shape of the carpenter's pencil.

4. The sharpener of claim 3, wherein said opening is shaped to match more than one size of a carpenter's pencil.

5. The sharpener of claim 3, wherein said centering collar opening is disposed concentrically to a rotational center of said contour surface.

6. The sharpener of claim 1, wherein said blade is held on said base enclosure by pins, at least one screw, or both.

7. The sharpener of claim 1, whrein said contour surface has a slope at an angle 10-13° relative to said central axis.
